(19) United States
(12) Patent Application Publication
(10) Pub. No.: US 2021/0157322 A1
(43) Pub. Date: May 27, 2021

(54) SYSTEMS AND METHODS FOR MARINE AUTONOMOUS STEERING

(71) Applicant: STEERING SOLUTIONS IP HOLDING CORPORATION, Saginaw, MI (US)

(72) Inventors: Patrik M. Ryne, Midland, MI (US); John E. Weber, Pinconning, MI (US); Rodney M. Sanderson, Midland, MI (US); Brian G. Maust, Unionville, MI (US)

(21) Appl. No.: 16/691,580

(22) Filed: Nov. 21, 2019

(51) Int. Cl. G05D 1/02; B63H 25/04; G01L 5/22

(52) U.S. Cl. CPC G05D 1/0206; G01C 17/00; G01L 5/221; B63H 25/04

(57) ABSTRACT

A method for steering control for a marine vessel includes determining a first position of a hand wheel of the marine vessel. The method also includes determining, after a first period, a second position of the hand wheel. The method also includes determining a difference between the first position of the hand wheel and the second position of the hand wheel. The method also includes, in response to a determination that the difference between the first position of the hand wheel and the second position of the hand wheel is less than a threshold: capturing a first heading of the marine vessel; and selectively controlling steering of the marine vessel according to the first heading.

### TECHNICAL FIELD

This disclosure relates to marine vessels and in particular to systems and methods for autonomous steering for marine vessels.

### BACKGROUND

Marine vessels, such as ships, boats, hovercrafts, submarines, personal watercrafts, and the like are increasingly provided with an autonomous or semi-autonomous steering system. Such systems may be configured to maintain a heading of a respective marine vessel while the system is engaged. For example, an operator of a marine vessel may engage an autonomous steering system when the marine vessel is traversing a steady course for a relatively long period. Such systems are typically an add-on feature to the marine vessel. Typically, such a system includes an electro-hydraulic pump, an electronic compass, and a course computer.

In order to engage the autonomous steering system, the operator of the marine vessel may actuate a switch located near a hand wheel of the marine vessel. Once the autonomous steering system is engaged, the course computer uses input from the electronic compass to determine a direction to steer the marine vessel. The course computer may then instruct the electro-hydraulic pump to send pressurized fluid to a hydraulic cylinder to turn a propulsion mechanism of the marine vessel to stay on the intended course. This may allow the operator of the marine vessel to perform other tasks within the marine vessel, while the autonomous steering system maintains the course of the marine vessel.

### SUMMARY

This disclosure relates generally to steering control for marine vessels.

An aspect of the disclosed embodiments includes a steering control system for a marine vessel. The system includes a processor and a memory. The memory includes instructions that, when executed by the processor, cause the processor to: determine a first position of a hand wheel of the marine vessel; determine, after a first period, a second position of the hand wheel; determine a difference between the first position of the hand wheel and the second position of the hand wheel; and in response to a determination that the difference between the first position of the hand wheel and the second position of the hand wheel is less than a threshold: capture a first heading of the marine vessel; and selectively control steering of the marine vessel according to the first heading.

Another aspect of the disclosed embodiments includes a method for steering control for a marine vessel. The method includes determining a first position of a hand wheel of the marine vessel. The method also includes determining, after a first period, a second position of the hand wheel. The method also includes determining a difference between the first position of the hand wheel and the second position of the hand wheel. The method also includes, in response to a determination that the difference between the first position of the hand wheel and the second position of the hand wheel is less than a threshold: capturing a first heading of the marine vessel; and selectively controlling steering of the marine vessel according to the first heading.

Another aspect of the disclosed embodiments includes a system for a marine vessel. The system includes a torque sensor, an electronic compass, a processor, and a memory. The torque sensor is configured to measure an amount of torque applied to a hand wheel of the marine vessel. The memory includes instructions that, when executed by the processor, cause the processor to: receive, from the electronic compass a first heading of the marine vessel and after a first period, receive, from the electronic compass, a second heading of the marine vessel; receive, from the torque sensor a first torque value of the hand wheel of the marine vessel and after the first period, receive, from the torque sensor, a second torque value of the hand wheel; determine a difference between the first torque value of the hand wheel and the second torque value of the hand wheel; determine difference between the first heading and he second heading; and in response to a determination that the difference between the first torque value and the second torque value is less than a torque threshold and that the difference between the first heading and the second heading is less than a heading threshold: set a course heading of the marine vessel according to the first heading; and selectively control steering of the marine vessel according to the course heading.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a steering system according to the principles of the present disclosure.

FIG. 2 generally illustrates an autonomous steering controller according to the principles of the present disclosure.

FIG. 3 is a flow diagram generally illustrating a steering control method according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, marine vessels, such as ships, boats, hovercrafts, submarines, personal watercrafts, and the like are increasingly provided with an autonomous or semi-autonomous steering system. Such systems may be configured to maintain a heading or course of a respective marine vessel while the system is engaged. For example, an operator of a marine vessel may engage an autonomous steering system when the marine vessel is traversing a steady course for a relatively long period. Such systems are typically an add-on feature to the marine vessel. Typically, such a system includes an electro-hydraulic pump, an electronic compass, and a course computer.

In order to engage the autonomous steering system, the operator of the marine vessel may actuate a switch The switch ay include a physical switch, such as a button or other suitable switch and may located near a hand wheel of the marine vessel, such as on a bridge of the marine vessel or other suitable location. Additionally, or alternatively, the switch may include an electronic switch, such as an electronic button or other suitable electronic switch, disposed on a multifunction display (MFD) of the marine vessel. The operator may depress the switch to engage the autonomous steering system and may depress the switch again to disengage the autonomous steering system.

Once the autonomous steering system is engaged, the course computer uses input, such as a heading or heading information, from the electronic compass to determine a direction to steer the marine vessel. The course computer may then instruct the electro-hydraulic pump to send pressurized fluid to a hydraulic cylinder to turn a propulsion mechanism of the marine vessel to stay on the intended course. The propulsion mechanism may include a propulsion engine, a propeller, a rudder, other suitable propulsion mechanisms, or a combination thereof.

Such autonomous steering systems may allow the operator of the marine vessel to perform other tasks within the marine vessel, while the autonomous steering system maintains the course of the marine vessel. However, during operation of such autonomous steering systems, if the operator engages the hand wheel (e.g., by turning the hand wheel), steering of the marine vessel may not respond or steering may respond erratically (e.g., “fighting” the operator) and then return to course. Use of the autonomous steering system may require foresight and thought on the part of the operator to engage or disengage the autonomous steering system at the appropriate time. In addition, if the autonomous steering system is left engaged or disengaged for too long or if the autonomous steering system is mistakenly engaged or disengaged, various safety issues mar arise. For example, the operator may be occupied with other tasks within the marine vessel and may assume the marine vessel is maintaining course (e.g., the operator may assume the autonomous steering system is engaged) when in reality, the marine vessel is not maintaining course. Further, the switch used to engage and disengage the autonomous steering system may add additional hardware to the marine vessel, may increase manufacturing costs, and may require significant weatherproofing to function properly in the marine environment.

Accordingly, systems and methods, such as the systems and methods described herein, that provide an autonomous steering system that allow the operator to intuitively engage and disengage the autonomous steering system, may be desirable. The system and methods descried herein may be configured to sense that the marine vessel has held a steady course within a calabratable number of degrees and/or a hand wheel angulation is below a calibratable number of degrees.

In some embodiments, the systems and methods described herein may be configured to determine whether the marine vessel has held the steady course and/or the hand wheel angulation has been below the number of degrees for a predetermined period. The systems and methods described herein may be configured to engage the autonomous steering system when the marine vessel has held the steady course and/or the hand wheel angulation has been below the number of degrees for the predetermined period. The systems and methods described herein may be configured to control electronic power steering of the marine vessel when the autonomous steering system is engaged to maintain a current heading of the marine vessel using the electronic compass, a global positioning system, and/or other suitable mechanism.

In some embodiments, the systems and methods described herein may be configured to sense a change in hand wheel angulation using a torque sensor. The systems and methods described herein may be configured to determine whether the change in hand wheel angulation is above a calibratable number of degrees and/or determine whether a hand wheel torque is greater than a calibratable predetermined torque value. The systems and methods described herein may be configured to disengage the autonomous steering system and allow the operator to control the marine vessel manually using the hand wheel, in response to a determination that the change in hand wheel angulation is above the number of degrees and/or the hand wheel torque value is greater than the predetermined torque value.

In some embodiments, the systems and methods described herein may be configured to determine a first position of a hand wheel of the marine vessel. The systems and methods described herein may be configured to determine, after a first period, a second position of the hand wheel. The systems and methods described herein may be configured to determine a difference between the first position of the hand wheel and the second position of the hand wheel. The systems and methods described herein may be configured to, in response to a determination that the difference between the first position of the hand wheel and the second position of the hand wheel is less than a threshold: capture a first heading of the marine vessel; and selectively control steering of the marine vessel according to the first heading.

In some embodiments, the systems and methods described herein may be configured to receive, from an electronic compass a first heading of the marine vessel. The systems and methods described herein may be configured to determine, from the electronic compass and after a first period, a second heading of the marine vessel. The systems and methods described herein may be configured to receive, from a torque sensor, a first torque value of the hand wheel of the marine vessel. The systems and methods described herein may be configured to, receive, from the torque sensor and after the first period, a second torque value of the hand wheel. The systems and methods described herein may be configured to determine a difference between the first torque value of the hand wheel and the second torque value of the hand wheel. The systems and methods described herein may be configured to determine difference between the first heading and he second heading. The systems and methods described herein may be configured to, in response to a determination that the difference between the first torque value and the second torque value is less than a torque threshold and that the difference between the first heading and the second heading is less than a heading threshold: set a course heading of the marine vessel according to the first heading; and selectively control steering of the marine vessel according to the course heading.

The systems and methods described herein may be configured to provide intuitive engagement and disengagement of the autonomous steering system. For example, the system and methods described herein may be configured to engage the autonomous steering system when the operator holds the marine vessel on a steady course for a defined period and disengage the autonomous steering system when the operator engages and/or turns the hand wheel (e.g., the operator does not have to actuate a switch to engage or disengage the autonomous steering system). Further, the systems and methods described herein may provide improved control of the marine vessel at relatively slow speeds.

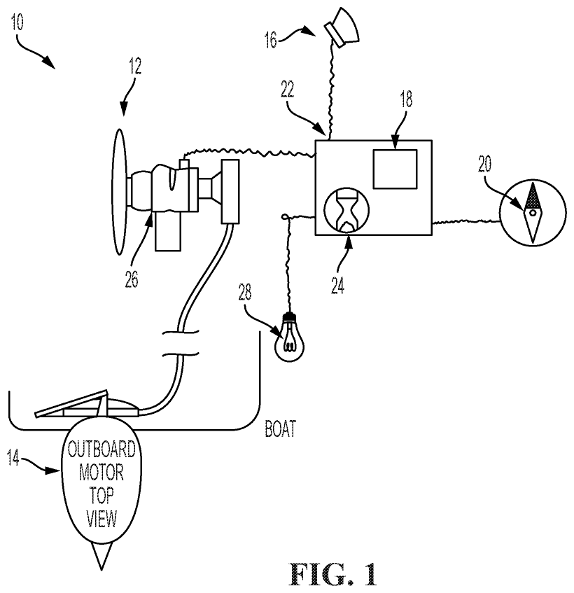

FIG. 1 generally illustrates a steering system 10 according to the principles of the present disclosure. The system 10 may be disposed in a marine vessel. The marine vessel may include any suitable marine vessel, such as those described herein. The system 10 may be configured to provide intuitive engagement and disengagement of the autonomous steering system, as described.

In some embodiments, the system 10 includes a steering mechanism or hand wheel 12. The hand wheel 12 may be disposed on a helm of the marine vessel or other suitable location. The operator of marine vessel engages the hand wheel 12 in order to control steering of the marine vessel. The system 10 includes a propulsion mechanism that includes a motor 14 and a rudder 16. While only the motor 14 and the rudder 16 are described herein, it should be understood that the propulsion mechanism may include additional or fewer components than described herein. For example, the propulsion mechanism may include one or more motors, a propulsion engine, one or more rudders, one or more propellers, other suitable components, or a combination thereof.

The motor 14 may include any suitable motor, such as an outboard motor, an inboard motor, and the like. The operator of the marine vessel may engage a throttle disposed proximate the hand wheel 12 to engage and/or control the motor 14. For example, the operator may increase or decrease a rotational velocity of a propeller associated with the motor 14 by actuating the throttle. Additionally, or alternatively, the operator may raise or lower the propeller of the motor 14 using one or more switches disposed on the throttle or proximate the throttle.

In some embodiments, the hand wheel 12 may be in direct communication with the rudder 16. For example, the system 10 may include a mechanism linkage that connects the hand wheel 12 to the rudder 16. As the operator turns the hand wheel 12, the mechanical linkage translates the rotation movement of the hand wheel 12, which causes the rudder 16 to move in a first direction or a second direction, opposite the first direction.

In some embodiments, the hand wheel 12 may be in indirection communication with the rudder 16. For example, the system 10 may include one or more sensors 26 disposed proximate the hand wheel 12 or remote from the hand wheel 12. The sensors 26 may include a torque sensor, a position sensor, other suitable sensor, or a combination thereof. For example, the sensors 26 may be include a torque sensor configured to measure a torque value corresponding to an amount of torque applied to the hand wheel 12 by the operator and a position sensor configured to measure a position of the hand wheel 12. The sensors 26 are configured to communicate sensor data to the controller 18. For example, the sensors 26 may be configured to communication the torque value, position, and/or any other suitable measurement to a controller 18. The controller 18 may be configured to control the rudder 16 according to the sensor data.

In some embodiments, the system 10 may include an electronic compass 20. The electronic compass 20 may be disposed within a controller housing 22 or external to the controller housing 22. The electronic compass 20 may be configured to determine a heading of the marine vessel. The electronic compass 20 is configured to communicate the heading to the controller 18. The controller 18 may be configured to provide the heading to the operator of the marine vessel. For example, the controller 18 may generate an output based on the heading. The controller 18 may provide the output to a display, such as an MFD of the marine vessel.

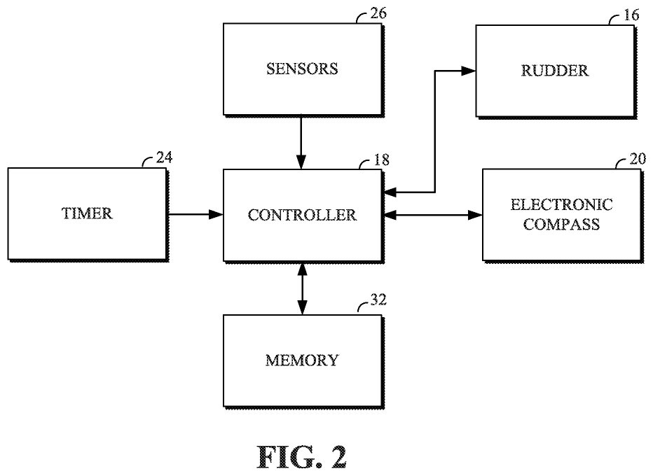

In some embodiments, the controller 18 may be configured to autonomously steer the marine vessel, as described. The controller 18 may include any suitable controller or processor, such as those described herein. The controller 18 may be configured to executed instructions stored on a memory, such as the memory 32, as is generally illustrated in FIG. 2. The memory 32 may comprise a single disk or a plurality of disks (e.g., hard drives), and includes a storage management module that manages one or more partitions within the memory 32. In some embodiments, memory 32 may include flash memory, semiconductor (solid state) memory or the like. The memory 32 may include Random Access Memory (RAM), a Read-Only Memory (ROM), or a combination thereof.

The instructions stored on the memory 32, when executed by the controller 18, cause the controller 18 to, at least, autonomously steer the marine vessel. The controller 18 is configured to determine whether to engage autonomous steering of the marine vessel. For example, the controller 18 may receive a first heading from the electronic compass 20. The controller 18 receives a second heading from the electronic compass 20. While only a first heading and a second heading are described, in some embodiments, the controller 18 may receive two or more headings from the electronic compass 20. For example, the controller 18 may receive a plurality of headings at predetermined intervals. In response to receiving the second heading from the electronic compass 20, the controller 18 determines whether a first predetermined period has expired. For example, the system 10 may include a timer 24. The timer 24 may include any suitable timer and may be disposed within the controller housing 22. The controller 18 determines whether the first predetermined period has expired using the timer 24. The first predetermined period may be any suitable period.

In some embodiments, the controller 18 may start the timer 24 in response to receiving the first heading. In some embodiments, the controller 18 may wait the first predetermined period and may request the second heading from the electronic compass 20. In some embodiments, the controller 18 may continuously receive headings from the electronic compass 20 and may disregard the headings unit the first predetermined period has expired. In some embodiment, the controller 18 may check an elapsed time on the timer 24 in response to receiving the second heading and determine whether the first predetermined period has expired based on the elapsed time.

If the controller 18 determines that the first predetermined period has not expired, the controller 18 disregards the second heading. The controller 18 may receive a subsequent heading and may determine if the first predetermined period has expired. If the controller 18 determines that the first predetermined period has expired, the controller 18 determines a difference between the first heading and the second heading. The controller 18 may then determine whether the difference between the first heading and he second heading is greater than a first predetermined number of degrees (e.g., a first threshold). The first predetermined number of degrees may be any suitable number of degrees. If the controller 18 determines that the difference between the first heading and the second heading is greater than the first predetermined number of degrees, the controller 18 does not engage autonomous steering of the marine vessel. Conversely, if the controller 18 determine that the difference between the first heading and the second heading is less than the first predetermined number of degrees, the controller 18 engages autonomous steering of the marine vessel. It should be understood that, in some embodiments, the controller 18 may receive a plurality of headings from the electronic compass 20 and may determine whether to engage autonomous steering of the marine vessel by determining whether differences between at least some of the plurality of headings are less than the first predetermined number of degrees.

In some embodiments, the controller 18 may the controller 18 may receive a first hand wheel position from the sensors 26. The first hand wheel position may indicate an angular position of the hand wheel 12 relative to a reference position of the hand wheel 12. The controller 18 may receive a second hand wheel position from the sensors 26. While only a first hand wheel position and a second hand wheel position are described, in some embodiments, the controller 18 may receive two or more hand wheel positions. For example, the controller 18 may receive a plurality of hand wheel positions at predetermined intervals. In response to receiving the second hand wheel position from the sensors 26, the controller 18 determines whether a second predetermined period has expired. For example, the controller 18 determines whether the second predetermined period has expired using the timer 24. The second predetermined period may be any suitable period. The second predetermined period may the same or different from the first predetermined period.

In some embodiments, the controller 18 may start the timer 24 in response to receiving the first hand wheel position. In some embodiments, the controller 18 may wait the second predetermined period and may request the second hand wheel position from the sensors 26. In some embodiments, the controller 18 may continuously receive hand wheel positions from the sensors 26 and may disregard the hand wheel positions unit the second predetermined period has expired. In some embodiment, the controller 18 may check an elapsed time on the timer 24 in response to receiving the second hand wheel position and determine whether the second predetermined period has expired based on the elapsed time.

If the controller 18 determine that the second predetermined period has not expired, the controller 18 may disregard the second hand wheel position. The controller 18 may receive a subsequent hand wheel positon and may determine whether the second predetermined period has expired. If the controller 18 determines that the second predetermined period has expired, the controller 18 determines a difference between the first hand wheel position and the second hand wheel position. The controller 18 may then determine whether the difference between the first hand wheel position and the second hand wheel position is greater than a second predetermined number of degrees (e.g., a second threshold). The second predetermined number of degrees may be any suitable number of degrees. If the controller 18 determines that the difference between the first hand wheel position and the second hand wheel position is greater than the second predetermined number of degrees, the controller 18 does not engage autonomous steering of the marine vessel. Conversely, if the controller 18 determine that the difference between the first hand wheel position and the second hand wheel position is less than the second predetermined number of degrees, the controller 18 engages autonomous steering of the marine vessel. It should be understood that, in some embodiments, the controller 18 may receive a plurality of hand wheel positions and may determine whether to engage autonomous steering of the marine vessel by determining whether differences between at least some of the plurality of hand wheel positions are less than the second predetermined number of degrees.

In some embodiments, the controller 18 determined whether to engage autonomous steering of the marine vessel in response to a determination that the difference between the first heading and the second heading is less than the first predetermined number of degrees and the difference between the first hand wheel position and the second hand wheel position is less than the second predetermined number of degrees. For example, the controller 18 may not engage autonomous steering of the marine vehicle unless both the difference in heading and the difference in hand wheel position are within the first predetermined number of degrees and the second predetermined number of degrees, respectively.

In some embodiments, the controller 18 may actuate an indicator 28 in response to the controller 18 engaging autonomous steering of the marine vessel. The indicator 28 may include a light or other suitable indicator. The indicator 28 may provide an indication to the operator of the marine vessel that autonomous steering of the marine vessel is engaged or disengaged (e.g., based on whether the indicator 28 is actuated)

In some embodiments, when the controller 18 engages autonomous steering of the marine vessel, the controller 18 captures a current heading of the marine vessel. For example, the controller 18 may request or receive the current heading from the electronic compass 20. The controller 18 selectively control the motor 14, the rudder 16, other suitable propulsion mechanism components, or a combination thereof according to the current heading. During engagement of autonomous steering of the marine vessel, the controller 18 may monitor the course of the marine vessel using headings received from the electronic compass 20, global position system coordinates received from a global positioning system of the marine vessel, other suitable information, or a combination thereof. The controller 18 may determine whether the marine vessel is holding the course based on the captured heading and the headings, the global position system coordinates, other suitable information, or a combination thereof. If the controller 18 determines that the marine vessel is not holding the course, the controller 18 may selectively control the motor 14, the rudder 16, other suitable propulsion mechanism components, or a combination thereof to correct the course of the marine vessel.

In some embodiments, the controller 18 may determine whether to disengage autonomous steering of the marine vessel in response to a torque value corresponding to the hand wheel 12. For example, during engagement of autonomous steering of the marine vessel, the controller 18 may monitor an amount of torque applied to the hand wheel 12. The controller 18 may receive torque values from the sensors 26. The torque values may indicate the amount of torque applied to the hand wheel 12.

The controller 18 may receive a first torque value from the sensors 26. The controller 18 compares the first torque value to a torque threshold. The torque threshold may include any suitable threshold. For example, the torque threshold may include a torque value indicative of engagement (e.g., turning) of the hand wheel 12 by the operator of the marine vessel. If the controller 18 determines that the first torque value is less than the torque threshold, the controller 18 continues to autonomously steer the marine vessel, as described, and continues to monitor the torque values received from the sensors 26. Conversely, if the controller 18 determines that the first torque value is greater than the torque threshold, the controller 18 disengages autonomous steering of the marine vessel. In this way, the controller 18 may disengage autonomous steering of the marine vessel responsive to the operator engaging (e.g., turning) the hand wheel 12. The controller 18 may subsequently engage autonomous steering of the marine vessel, as described (e.g., based on the headings and/or hand wheel position).

In some embodiments, the controller 18 may perform the methods described herein. However, the methods described herein as performed by controller 18 are not meant to be limiting, and any type of software executed on a controller can perform the methods described herein without departing from the scope of this disclosure. For example, a controller, such as a processor executing software within a computing device, can perform the methods described herein.

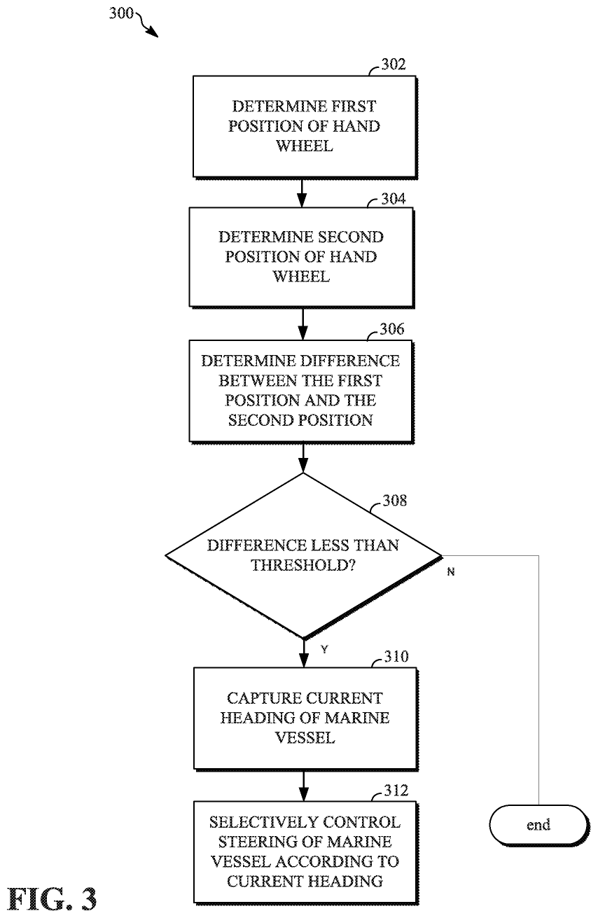

FIG. 3 is a flow diagram generally illustrating a steering control method 300 according to the principles of the present disclosure. At 302, the method 300, determines a first position of a hand wheel. For example, the controller 18 receives the first hand wheel position of the hand wheel 12 from the sensors 26. Additionally, or alternatively, the controller 18 may receive a first torque value from the sensors 26. The controller 18 may derive the first hand wheel position based on the first torque value. At 304, the method 300 determines a second positon of the hand wheel. For example, the controller 18 may receive the second hand wheel position of the hand wheel 12 from the sensors 26. Additionally, or alternatively, the controller 18 may receive a second torque value from the sensors 26. The controller 18 may derive the second hand wheel position based on the second torque value. In some embodiments, the method 300 includes determining and/or receiving the first heading and the second heading. For example, the controller 18 may receive the first heading and the second heading from the electronic compass 20.

At 306, the method 300 determines a difference between the first position and the second position. For example, the controller 18 determines the difference between the first hand wheel position and the second hand wheel position. In some embodiments, the method 300 includes determining a difference between the first heading and the second heading. For example, the controller 18 determines the difference between the first heading and the second heading. At 308, the method 300 determines whether the difference is less than a threshold. For example, the controller 18 determines whether the difference between the first hand wheel position and the second hand wheel position is less than the second predetermined number of degrees. If the controller 18 determines that the difference between the first hand wheel position and the second hand wheel position is greater than the second predetermined number of degrees, the method 300 ends. If the controller 18 determines the difference between the first hand wheel positon and the second hand wheel position is less than the second predetermined number of degrees, the method 300 continues at 310.

In some embodiments, the method 300 includes determining whether the difference between the first heading and the second heading is less than the first predetermined number of degrees. For example, the controller 18 determines whether the difference between the first heading and the second heading is less that the first predetermined number of degrees. If the controller 18 determine that the difference between the first heading and the second heading is greater than the first predetermined number of degrees, the method 300 ends. Conversely, if the controller 18 determines that the difference between the first heading and the second heading is less than the first predetermined number of degrees, the method 300 continues at 310. In some embodiments, the method 300 ends if either of the difference between the first hand wheel positon and the second hand wheel positon or the difference between the first heading and the second heading is greater than the second predetermined number of degrees and the first predetermined number of degrees, respectively

At 310, the method 300 captures a current heading of the marine vessel. For example, the controller 18 captures the current heading of the marine vessel. The controller 18 may receive or request the current heading from the electronic compass 20. At 312, the method 300 selectively controls steering of the marine vessel according to the current heading. For example, the controller 18 controls the motor 14, the rudder 16, other components of the propulsion mechanism or a combination thereof according to the current heading. The controller 18 may perform various course corrections in response to a difference between the current heading and a subsequent heading received from the electronic compass 20 being above a threshold. The controller 18 may disengage autonomous steering of the marine vessel in response to receiving a torque value from the sensors 26 that is greater than the torque threshold.

In some embodiments, a steering control system for a marine vessel includes a processor and a memory. The memory includes instructions that, when executed by the processor, cause the processor to: determine a first position of a hand wheel of the marine vessel; determine, after a first period, a second position of the hand wheel; determine a difference between the first position of the hand wheel and the second position of the hand wheel; and in response to a determination that the difference between the first position of the hand wheel and the second position of the hand wheel is less than a threshold: capture a first heading of the marine vessel; and selectively control steering of the marine vessel according to the first heading.

In some embodiments, the instructions further cause the processor to receive a torque value corresponding to an amount of torque applied to the hand wheel. In some embodiments, the instructions further cause the processor to determine whether the torque value is greater than a torque threshold. In some embodiments, the instructions further cause the processor to continue steering control of the marine vessel according to the heading in response to a determination that the torque value is less than the torque threshold. In some embodiments, the instructions further cause the processor to discontinue steering control steering of the marine vessel in response to a determination that the torque value is greater than the torque threshold. In some embodiments, the instructions further cause the processor to determine, after a second period, a second heading of the marine vessel. In some embodiments, the instructions further cause the processor to determine a difference between the first heading and the second heading. In some embodiments, the instructions further cause the processor to, in response to the difference between the first heading and the second heading being greater than a heading threshold, correct course of the marine vessel.

In some embodiments, a method for steering control for a marine vessel includes determining a first position of a hand wheel of the marine vessel. The method also includes determining, after a first period, a second position of the hand wheel. The method also includes determining a difference between the first position of the hand wheel and the second position of the hand wheel. The method also includes, in response to a determination that the difference between the first position of the hand wheel and the second position of the hand wheel is less than a threshold: capturing a first heading of the marine vessel; and selectively controlling steering of the marine vessel according to the first heading.

In some embodiments, the method also includes receiving a torque value corresponding to an amount of torque applied to the hand wheel. In some embodiments, the method also includes determining whether the torque value is greater than a torque threshold. In some embodiments, the method also includes continuing steering control of the marine vessel according to the heading in response to a determination that the torque value is less than the torque threshold. In some embodiments, the method also includes discontinuing steering control steering of the marine vessel in response to a determination that the torque value is greater than the torque threshold. In some embodiments, the method also includes determining, after a second period, a second heading of the marine vessel. In some embodiments, the method also includes determining a difference between the first heading and the second heading. In some embodiments, the method also includes, in response to the difference between the first heading and the second heading being greater than a heading threshold, correcting course of the marine vessel.

In some embodiments, a system for a marine vessel includes a torque sensor, an electronic compass, a processor, and a memory. The torque sensor is configured to measure an amount of torque applied to a hand wheel of the marine vessel. The memory includes instructions that, when executed by the processor, cause the processor to: receive, from the electronic compass a first heading of the marine vessel and after a first period, receive, from the electronic compass, a second heading of the marine vessel; receive, from the torque sensor a first torque value of the hand wheel of the marine vessel and after the first period, receive, from the torque sensor, a second torque value of the hand wheel; determine a difference between the first torque value of the hand wheel and the second torque value of the hand wheel; determine difference between the first heading and he second heading; and in response to a determination that the difference between the first torque value and the second torque value is less than a torque threshold and that the difference between the first heading and the second heading is less than a heading threshold: set a course heading of the marine vessel according to the first heading; and selectively control steering of the marine vessel according to the course heading.

In some embodiments, the instructions further cause the processor to receive, after a second period, a third torque value from the torque sensor. In some embodiments, the instructions further cause the processor to continue steering control of the marine vessel according to the heading in response to a determination that the third torque value is less than the torque threshold. In some embodiments, the instructions further cause the processor to discontinue steering control steering of the marine vessel in response to a determination that the third torque value is greater than the torque threshold.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

What is claimed is:

1. A steering control system for a marine vessel, the system comprising:
a processor; and
a memory that includes instructions that, when executed by the processor, cause the processor to:
determine a first position of a hand wheel of the marine vessel;
determine, after a first period, a second position of the hand wheel;
determine a difference between the first position of the hand wheel and the second position of the hand wheel; and
in response to a determination that the difference between the first position of the hand wheel and the second position of the hand wheel is less than a threshold:
capture a first heading of the marine vessel; and
selectively control steering of the marine vessel according to the first heading.

2. The system of claim 1, wherein the instructions further cause the processor to receive a torque value corresponding to an amount of torque applied to the hand wheel.

3. The system of claim 2, wherein the instructions further cause the processor to determine whether the torque value is greater than a torque threshold.

4. The system of claim 3, wherein the instructions further cause the processor to continue steering control of the marine vessel according to the heading in response to a determination that the torque value is less than the torque threshold.

5. The system of claim 3, wherein the instructions further cause the processor to discontinue steering control steering of the marine vessel in response to a determination that the torque value is greater than the torque threshold.

6. The system of claim 1, wherein the instructions further cause the processor to determine, after a second period, a second heading of the marine vessel.

7. The system of claim 6, wherein the instructions further cause the processor to determine a difference between the first heading and the second heading.

8. The system of claim 7, wherein the instructions further cause the processor to, in response to the difference between the first heading and the second heading being greater than a heading threshold, correct course of the marine vessel.

9. A method for steering control for a marine vessel, the method comprising:
determining a first position of a hand wheel of the marine vessel;
determining, after a first period, a second position of the hand wheel;
determining a difference between the first position of the hand wheel and the second position of the hand wheel; and
in response to a determination that the difference between the first position of the hand wheel and the second position of the hand wheel is less than a threshold:
capturing a first heading of the marine vessel; and
selectively controlling steering of the marine vessel according to the first heading.

10. The method of claim 9, further comprising receiving a torque value corresponding to an amount of torque applied to the hand wheel.

11. The method of claim 10, further comprising determining whether the torque value is greater than a torque threshold.

12. The method of claim 11, further comprising continuing steering control of the marine vessel according to the heading in response to a determination that the torque value is less than the torque threshold.

13. The method of claim 11, further comprising discontinuing steering control steering of the marine vessel in response to a determination that the torque value is greater than the torque threshold.

14. The method of claim 9, further comprising determining, after a second period, a second heading of the marine vessel.

15. The method of claim 14, further comprising determining a difference between the first heading and the second heading.

16. The method of claim 15, further comprising, in response to the difference between the first heading and the second heading being greater than a heading threshold, correcting course of the marine vessel.

17. A system for a marine vessel, the system comprising:
a torque sensor configured to measure an amount of torque applied to a hand wheel of the marine vessel;
an electronic compass;
a processor; and
a memory that includes instructions that, when executed by the processor, cause the processor to:
receive, from the electronic compass:
a first heading of the marine vessel; and
after a first period, second heading of the marine vessel receive, from the torque sensor:
a first torque value of the hand wheel of the marine vessel; and
after the first period, a second torque value of the hand wheel;
determine a difference between the first torque value of the hand wheel and the second torque value of the hand wheel;
determine difference between the first heading and he second heading; and
in response to a determination that the difference between the first torque value and the second torque value is less than a torque threshold and that the difference between the first heading and the second heading is less than a heading threshold:
set a course heading of the marine vessel according to the first heading; and
selectively control steering of the marine vessel according to the course heading.

18. The system of claim 17, wherein the instructions further cause the processor to receive, after a second period, a third torque value from the torque sensor.

19. The system of claim 18, wherein the instructions further cause the processor to continue steering control of the marine vessel according to the heading in response to a determination that the third torque value is less than the torque threshold.

20. The system of claim 18, wherein the instructions further cause the processor to discontinue steering control steering of the marine vessel in response to a determination that the third torque value is greater than the torque threshold.
